(19) United States
(12) Patent Application Publication
(10) Pub. No.: US 2002/0084642 A1
(43) Pub. Date: Jul. 4, 2002

(54) Removable stabilizer for recreational vehicles

(76) Inventor: Marc Dussault, Ste-Marthe du cap (CA)

Correspondence Address: Marc Dussault, 210 , 9th street, Ste-Marthe du Cap, Quebec, G8T 7X7, CA

(21) Appl. No.: 09/775,730

(22) Filed: Jan. 28, 2001

(30) Foreign Application Priority Data
Nov. 6, 2000 (CA) 2 324 693

(51) Int. Cl. B60S 9/02

(52) U.S. Cl. 280/763.1; 280/762

(57) ABSTRACT

My invention is a simple, detachable stabilizing system that is used to stabilize stationary recreational vehicles or trailers that would otherwise be unstable due to their non rigid suspension systems. Although such stabilizing systems are already commercially available, my invention is unique in that it maximizes the leverage applied against the supporting legs, thus increasing its load bearing and stability characteristics over those of other systems. My invention represents a further improvement over permanently affixed systems in that it is simple to affix to the frame of any recreational vehicle or trailer—no tools required—and it is easy to remove and convenient to store when not in use. Thus, my invention is not susceptible to damage from road dirt, grime and/or obstructions to movement (e.g., speed bumps or curbs), as any permanently affixed system is. Finally, my invention represents an improvement over the other removable system in that, should the owner forget to remove my invention before moving his/her recreational vehicle or trailer, it will sustain minimal, if any, damage.

### SUMMARY

When camping with a travel trailer or motorized vehicle, there is a requirement to level the trailer with jacks when arriving at a new site. To prevent the vehicle from swaying from side to side, one or more stabilizers are installed on the trailer's frame with cranks. The stabilizer are adjusted to form an angle between the vehicle and the ground to stop the sideway movements. The invention presented herein nullifies the need for a part fixed to the frame, the crank and the lever-screw system. The invention has three parts:

1-2) legs (pieces of metal in angle with the ground); and

3) a strap linking the legs to the base.

The end of the leg supporting the frame of the vehicle has a notch to hold it into position and allowing some movement. The other end has a curved piece of metal (a ski) the prevents the leg from digging into the ground. The strap has a hook or a loop at each end that hooks into a hole or a ring at the end of the ski. The strap has a crank to allow tightening, pulling the skis towards each other.

### REMOVABLE RECREATIONAL VEHICULE STABILIZER

An apparatus made of three parts; two rigid legs and a tension system. The two legs are leaning against the frame of the vehicule at the top and spreading at the bottom where they touch the ground. The tension system (strap and crank) is hooked at the base of the legs and pulls them closer. When under tension the weight, of the vehicule works against the forces generated by the legs resulting in a considerable reduction of side to side motion.

[image]

### DESCRIPTIVE MEMOIR

The invention described herein consists of a stabilizing system for recreational vehicles (RVs).

A stabilizing system already exists in the current market and is used to stabilize the rear end of an RV. It includes a part permanently fitted to the RV's frame, which is composed of a lever-screw system at each end of the vehicle. When the screw is activated with a lever, a metallic part (leg) is lowered and sits on the ground in an angle. The force against the ground is controlled using the lever (while turning). Two models are already sold on the market, 20 inches and 24 inches, to fulfill the need of various RVs.

The system is efficient, however, it must be permanently attached to the RV, which exposes it to weather and road conditions, causing the screw to rust and jam. It must be attached to a specific area of the frame, i.e. between the rear wheels and the rear bumper, and where it will allow free use of the RV's equipment such as sewer system, plumbing drains, gas lines, mud guards, protective iron-angles, and so on. The system must be operated while using a specific lever when lowering and storing the support legs. While the legs are lowered, any movement of the vehicle could bend or destroy the system, systeme. The two current models are sold for a price of $139 Canadian and $149 Canadian approximately.

Another system exists, however, I could not assert its existence on the market. It is composed of three parts, as my invention is. Two tubular legs are set against the frame to support it, in an ouward angle, where a chain links both legs at the base. The top part of each leg has a screw that, when turned in one way, allows to strech the leg and push against the RV upwards. This system can only be installed where the screws can be easily accessed, close to the frame. The time needed for installing and uninstalling this system is greater than the previously described system. This second system is carried in a storing space in the RV. I have only seen home-made models, the cost of which should be comparable to that of my invention.

### THE ORIGIN OF THE CONCEPT

I figured that by installing the stabilizer at that rear end of theframe of the recreational vehicle (RV), just before the bumper, it performed much better. By bringing closer the base of the stabilizing legs with the tension system (binder), the weight of the RV is spread out more evenly. The system has three components, can be carried safely away from bad weather and can be used on multiple vehicles. It can be accessed easily when installing and uninstaling, and allows easy setting of tension. It is very visible, which decreases the possibility of forgetting it. If the user forgets to uninstall the system before moving the vehicle, damages to the system and the vehicle will be minimum.

The system I am illustrating may be used for an end somewhat different to the original purpose. New and used RVs are put to sale and displayed without being leveled or supported properly with appropieate jacks. Most RV is sold without jacks, which are optional. Most RVs displayed are supported by the tires, which makes the RV instable, and the visit insite incomfortable due to the swinging. My invention is so easy to instrall that it would allow RV salemen to install and uninstall the system on RVs, regardless of the type of ground, and still allow the system to be sold as an option since it is removable.

### INVENTION

The best method to use my invention is as follows: (referring to Detail number 1 and number 2) the notch at the top of a piece of metal (the leg) leans against the frame of the vehicle at the indicated location. At the other end, a curved piece of metal (ski) sits on the ground at an angle of approximately 45 degrees (towards the outside of the RV). Both legs are installed opposite, on each end of the RV. When the ground is soft or uneaven, a piece of wood can be used under the ski. A strap with a hook on each end an a jack at the center is layed on the ground, between the legs. The hoks are inserted in the holes on the end of the skis. The jack on the strap tightens the strap and brings the skis closer together. Decreasing the distance between the skis creates an upward force. In reverse, a downward force towrads is created by the RV. The greater the downward force, the greater the stability since the legs are installed opposite way. The angle of the legs affects the stability, which becomes nil when the angle of the leg with the vehicle is close to 90 degrees. I believe that an angle between 45 and 60 degrees would be ideal. Tightening the strap will bring the RV's frame away from the ground. For better results, I recommend levelling with appropriate jacks before installing the stabilizer. The tension in the strap will be such that it will create a balance between the jacks and the stabilizing system.

[image]

[image]

[image]

[image]

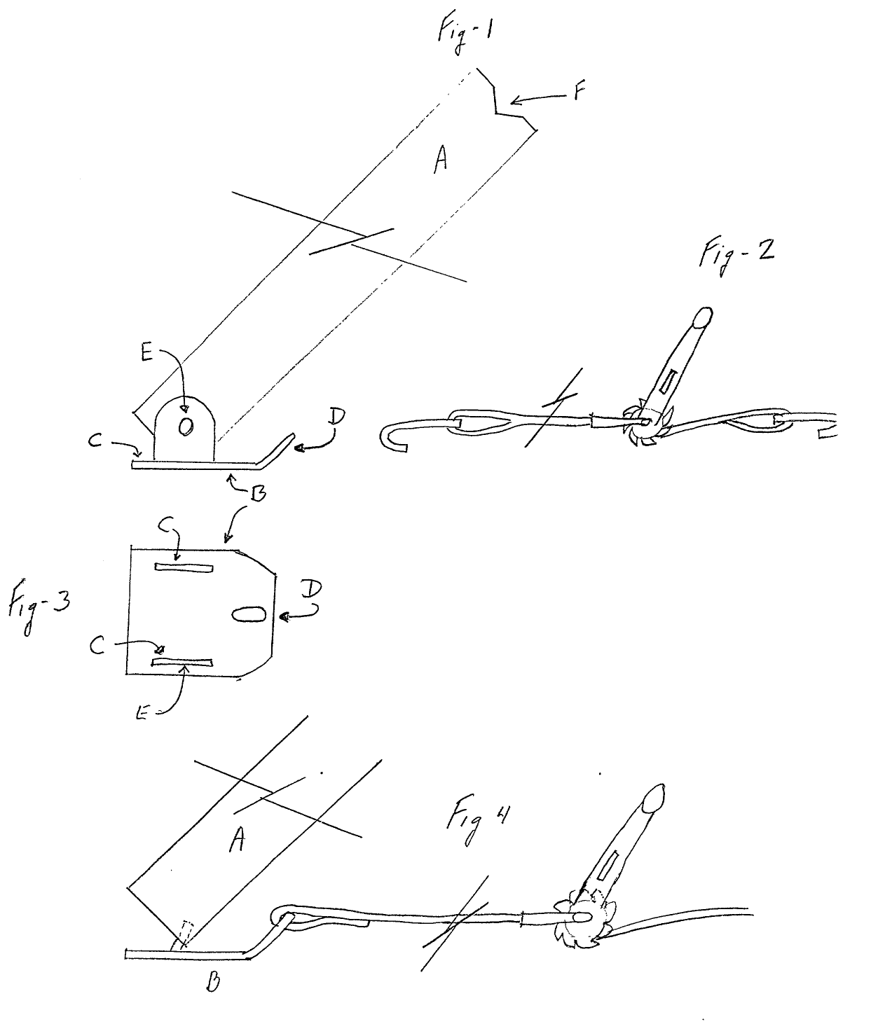

FIG. 1 illustrates one of the two legs.

FIG. 2 illustrates the tension system.

FIG. 3 illustrates aside view of the leg base (ski).

FIG. 4 illustrates an alternative to the ski, an the method to fit the ski to the leg.

The illustrated stabilizer includes two legs (A) at the end of which a ski (B) is connected to the leg by a metal part (C) and a rod passing through a hole (E).

The hole on the tip of the ski (D) allows to hook the binder (tension system) to both legs. The notch (F) in the legs supports the frame of the vehicle and allows some movement.

The height of the leg (A) is adjustable to the height of the vehicle. The strength of the binder must be picked according to the weight of the vehicle.

A variation of the system is fixed skis at each end of the binder. The skis would not have the piece of metal (C). A different piece of metal would be welded to the center of the ski, which would hook up to the base of the leg (A). See FIG. 4.

Regardless of the version, the system is designed to be easy to install, uninstall and carry.

Pictures number 1 to 5 illustrate the system when installed on a recreational vehicle (RV) of 10,400 pounds (4,700 kg).

FIGS. 5 and 6 illustrate the rear of the RV, and FIG. 7 indicates the details of the instalation. Picture 6 illustrates the two variations of the tension systems (binder) for heavier and lighter RVs.

The product of the invention, for which an ownership right or privilege is revendiqué, is defined as follows:

1. A manual instrument used to stabilize all types of recreational vehicles (Rvs) or other types of vehicles when the vehicle is parked temporarily or permanently. The instrument is composed of three parts: two legs and a strap with a tention system.

2. An instrument, as described at paragraph 1, where each leg has a notch at its upper part, allowing the leg to hook up temporarily to the frame of the vehicle.

3. An instrument, as described at paragraph 1 and 2, where the lower part of the leg sits on a curved piece of metal or other material, allowing the leg to slip on the ground. This part can either be attached to the end of the leg, or attached to the each end of the tention system, with a linking mechanism to attach the legs to the strap using holes, hooks and/or loops.

4. An instrument, as described at paragraph 1, 2 and 3 where the parts described at 3 would be linked together by a tightening system strong enough to pull the legs towards one another. Such system would be made of chains, steel cable or other straps. The tension system is attached to the curved part at the end of the leg (described at paragraph 3) with hooks, loops or other linking device.

5. An instrument, as described at paragraph 1, 2, 3 and 4 where the tension system includes a click, ratchet wheel or other tightener to tighten or raise the tension and keep the tension level constant.

6. An instrument, as described at paragraph 1, 2, 3, 4 and 5 which the size, length and support capacity can be adjusted to the size and weight of various RVs.
